(19) United States
(12) Patent Application Publication
(10) Pub. No.: US 2015/0037454 A1
(43) Pub. Date: Feb. 5, 2015

(54) MOLD ASSEMBLY FOR FOMRING OPTICAL LENS FOR LED

(71) Applicant: Hon Hai Precision Industry Co., Ltd., New Taipei (TW)

(72) Inventor: PO-CHOU CHEN, Tu-Cheng (TW)

(73) Assignee: Hon Hai Precision Industry Co., Ltd., New Taipei (TW)

(21) Appl. No.: 14/022,237

(22) Filed: Sep. 10, 2013

(30) Foreign Application Priority Data
Jul. 31, 2013 (TW) 102127379

(51) Int. Cl. B29C 45/26

(52) U.S. Cl. CPC B29C 45/2673
USPC 425/577

(57) ABSTRACT

A mold assembly for manufacturing an optical lens for LED, includes an upper die, an upper die core received in the upper die, a bottom die and a bottom die core received in the bottom die. The upper die core includes a bottom surface; the bottom surface has a profile corresponding to a profile of a top portion of the optical lens. The bottom die includes a base and a replaceable die core removably received in the base. The replaceable die core includes an upper surface, and the replaceable die core defines a chamber depressed downwardly at a center of the upper surface. A bottom portion of the optical lens is formed by in the chamber. The replaceable die core defines a plurality of fixing holes recessed downwardly from the chamber for forming positioning feet of the optical lens.

### BACKGROUND

1. Technical Field

The present disclosure relates to a mold assembly for forming an optical lens, and particularly to a mold assembly for forming an optical lens for LED (light emitting diode), wherein the mold assembly has a replaceable die core for forming positioning feet of the optical lens.

2. Description of Related Art

LEDs have been widely promoted as light sources of electronic devices owing to many advantages, such as high luminosity, low operational voltage and low power consumption. An optical lens is usually added on the light path of the LED to change the light field of the light generated by the LED to suit different occasions. The optical lens has positioning feet acting as the positioning structure to precisely position the optical lens relative to the LED whereby an optical axis of the LED can align with a center of the optical lens.

However, to different requirements and applications, the number and position of the positioning feet of the optical lenses are different for different lenses which may have the lens bodies thereof having the same configuration and size. For manufacturing such different optical lenses, different mold assemblies should be developed, whereby the cost of manufacturing the lenses is great.

Therefore, a mold assembly for forming optical lens which is capable of overcoming the above-described shortcomings is desired.

### BRIEF DESCRIPTION OF THE DRAWINGS

Many aspects of the present disclosure can be better understood with reference to the following drawings. The components in the drawings are not necessarily drawn to scale, and certain one or more of the views are schematic; the emphasis instead being placed upon clearly illustrating the principles of the present disclosure. Moreover, in the drawings, like reference numerals designate corresponding parts throughout the several views.

FIG. 1 shows a schematic view of a mold assembly for forming an optical lens for an LED (light emitting diode) in accordance with an embodiment of the present disclosure.

FIG. 2 shows an exploded view of the mold assembly of FIG. 1.

FIG. 3 shows an exploded, inverted view of the mold assembly of FIG. 1.

FIG. 4 shows a cross-sectional view of the mold assembly of FIG. 1, taken along a line IV-IV thereof.

### DETAILED DESCRIPTION

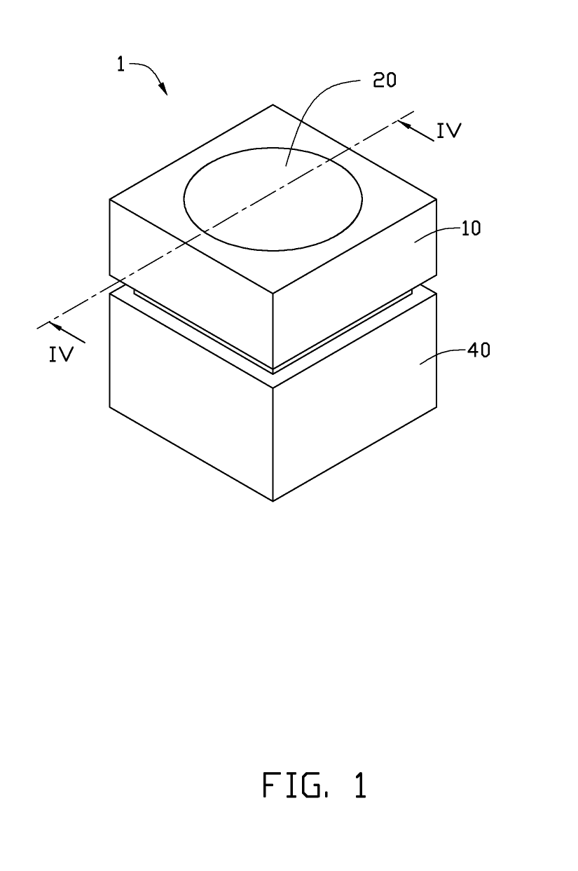

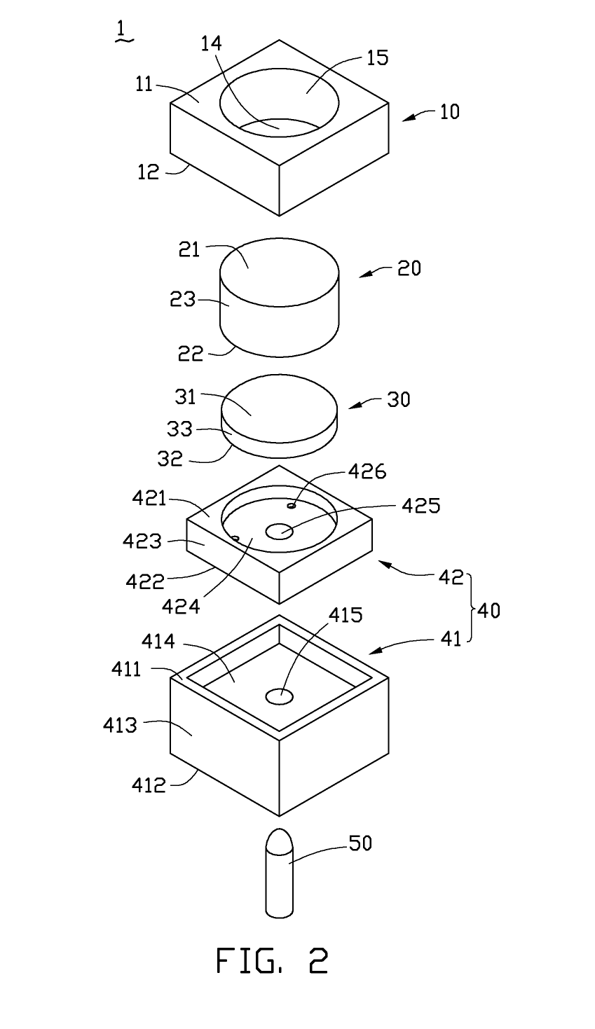

Referring to FIGS. 1 and 2, a mold assembly 1 for manufacturing an optical lens 30 in accordance with an exemplary embodiment of the present disclosure includes an upper die 10, an upper die core 20 received in the upper die 10, a bottom die 40 and a bottom die core 50 received in the bottom die 40.

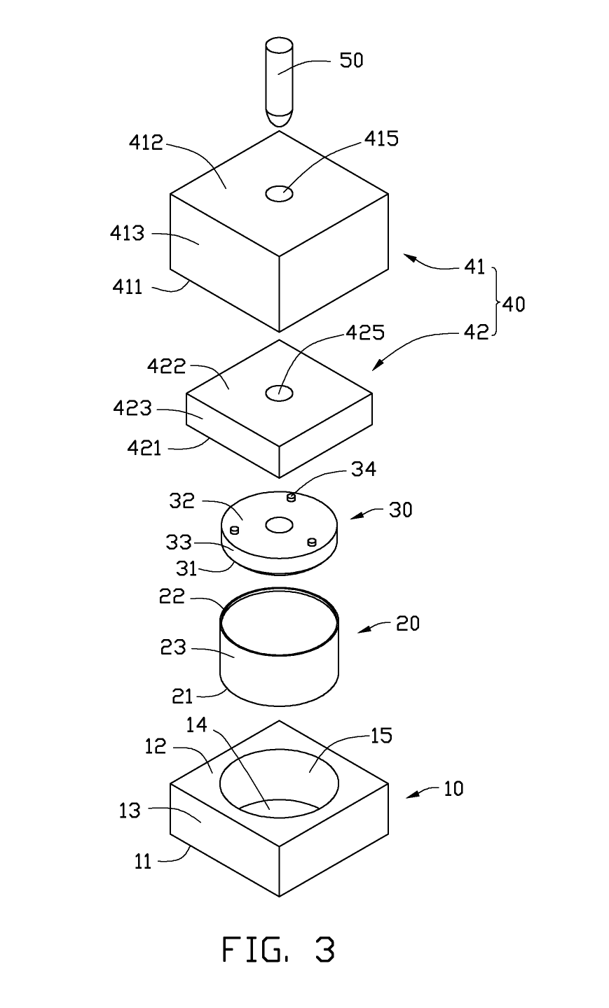

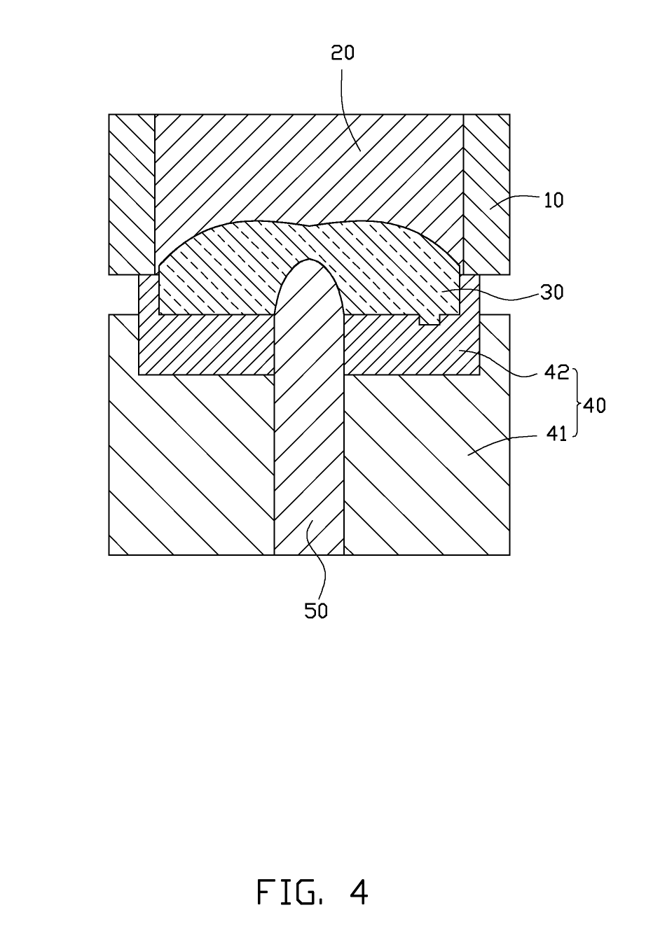

Referring to FIGS. 3 and 4 also, the optical lens 30 includes a top surface 31, a bottom surface 32 and a lateral surface 33 interconnecting the top surface 31 with the bottom surface 32. In this embodiment, the top surface 31 is a curved surface, and a plurality of positioning feet 34 are formed on the bottom surface 32. The optical lens 30 is shown for easily understanding the mold assembly 1 in accordance with the present disclosure. To a person skilled in the art, it can be easily understood that the optical lens 30 is not a part of the mold assembly 1 but a product to be formed by the mold assembly after plastic material is injection molded in the mold assembly 1. The optical lens 30 in the shown embodiment is configured for diverging light from an LED (light emitting diode, not shown) covered by the optical lens 30. Other configuration of the optical lens 30 can achieve other optical functions.

The upper die 10 is a hollow square cylinder, and includes an upper surface 11, a lower surface 12 and an outer lateral surface 13 interconnecting the upper surface 11 with the lower surface 12. The upper die 10 defines a void 14 running through the upper surface 11 and the lower surface 12, and the void 14 is defined by an inner lateral surface 15 of the upper die 10. In this embodiment, the void 14 is cylindrical.

The upper die core 20 is received in the void 14 of the upper die 10, and is cylindrical. The upper die core 20 is symmetric relative to a central axis OO′ thereof. The upper die core 20 includes a top surface 21, a bottom surface 22 and a lateral surface 23 interconnecting the top surface 21 and the bottom surface 22. The top surface 21 of the upper die core 20 is coplanar with the upper surface 11 of the upper die 10, the lateral surface 23 of the upper die core 20 is attached to the inner lateral surface 15 of the upper die 10, and the peripheral edge of the bottom surface 22 is coplanar with the lower surface 12 of the upper die 10. The bottom surface 22 is a recessed and curved surface, and has a profile corresponding to a profile of the top surface 31 of the optical lens 30.

The bottom die 40 is a square cylinder, and includes a base 41 and a replaceable die core 42 removably received in the base 41.

The base 41 is a hollow square cylinder, and includes an upper surface 411, a lower surface 412 and an outer lateral surface 413 interconnecting the upper surface 411 with the lower surface 412. The base 41 defines a first chamber 414 depressed downwardly at a middle of the upper surface 411 thereof, and defines a first hole 415 located at a center thereof and extending upwardly from the lower surface 412 to a top of the base 41 to communicate with the first chamber 414. In this embodiment, the first chamber 414 is square, and the first hole 415 is round.

The replaceable die core 42 is received in the first chamber 414 of the base 41. The replaceable die core 42 includes an upper surface 421, a lower surface 422 attached on a face of the base 41 defining a bottom of the first chamber 414 and an outer lateral surface 423 attached on faces of the base 41 defining lateral sides of the first chamber 414. The replaceable die core 42 defines a second chamber 424 depressed downwardly at a middle of the upper surface 421 thereof, and defines a second hole 425 located at a center thereof and extending upwardly from the lower surface 422 to a top of the replaceable die core 42 to communicate with the second chamber 424. The second hole 425 is aligned with the first hole 415, whereby the first hole 415 is also communicated with the second chamber 424 of the replaceable die core 42. In this embodiment, the bottom of the optical lens 30 is fitly received in the second chamber 424, and the replaceable die core 42 defines a plurality of fixing holes 426 recessed downwardly from the chamber 424 for forming the positioning feet 34 of the optical lens 30. By changing the replaceable die core 42 with another replaceable die core having the fixing holes 426 with different numbers and/or positions and/or sizes, the configuration of the positioning feet 34 of the optical lens 30 is changeable.

The bottom die core 50 is columnar, and has a curved top face. The bottom die core 50 is removably received in the first hole 415 of the base 41 and the second hole 425 of the replaceable die core 42, and the top portion of the bottom die core 50 is located in the second chamber 424 of the replaceable die core 42. The top portion of the bottom die core 50 is used to form a curved recess in a center of the bottom face 32 of the optical lens 30 (better seen in FIG. 3). The curved recess (not labeled) is used for more powerfully diverging light from a center of an LED which is most intensive.

In assembly, firstly, the replaceable die core 42 is received in the first chamber 414 of the base 41, and the upper surface 421 of the replaceable die core 42 is higher than the upper surface 411 of the base 41, and the bottom die core 50 is inserted into the second chamber 424 of the replaceable die core 42 from the first hole 415 of the base 41 and the second hole 425 of the replaceable die core 42. Secondly, the upper die core 20 is received in the void 14 of the upper die 10. Finally, the upper surface 421 of the replaceable die core 42 abuts against the lower surface 12 of the upper die 10, and the outer lateral surface 413 is coplanar with the outer lateral surface 13 of the upper die 10. Then the upper die 10, the upper die core 20, the bottom die 40 and the bottom die core 50 cooperatively define a room, and the room has a same profile as that of optical lens 30 for manufacturing the optical lens 30.

In summary, for the bottom die 40 having the replaceable die core 42, and the replaceable die core 42 defining a plurality of fixing holes 426, in the process for manufacturing different optical lenses with different positioning feet, only the replaceable die core 42 is needed to be changed whereby the cost for manufacturing the optical lens and the mold assembly is reduced.

Even though aspects of particular embodiments are shown in the drawings and corresponding descriptions are provided herein, the entire disclosure is by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A mold assembly for manufacturing an optical lens for an LED (light emitting diode), comprising:
an upper die;
an upper die core received in the upper die;
a bottom die; and
a bottom die core received in the bottom die;
wherein the upper die core has a bottom surface, the bottom surface has a profile corresponding to a profile of a top portion of the optical lens, the bottom die comprises a base and a replaceable die core removably received in the base, the replaceable die core has an upper surface, and the replaceable die core defines a chamber depressed downwardly at a central portion of the upper surface thereof, the chamber being configured for forming a bottom portion of the optical lens, and the replaceable die core defines a plurality of fixing holes recessed downwardly from the chamber and configured for forming positioning feet of the optical lens when plastic material is injection molded in the mold assembly to form the optical lens.

2. The lens mold assembly of claim 1, wherein the upper die defines a void receiving the upper die core therein.

3. The lens mold assembly of claim 1, wherein the base comprises an upper surface, a lower surface and an outer lateral surface interconnecting the upper surface and the lower surface, the base defines another chamber depressed downwardly at a middle of the upper surface thereof, and defines a first hole at a center thereof, the first hole extends upwardly from the lower surface thereof to communicate with the another chamber, and the replaceable die core is removably received in the another chamber of the base.

4. The lens mold assembly of claim 3, wherein the replaceable die core defines a second hole thereof, the second hole is aligned with the first hole, the first hole and the second hole are both communicated with the chamber of the replaceable die core, the bottom die core is received in the first hole of the base and the second hole of the replaceable die core, and the top portion of the bottom die core is located in the chamber of the replaceable die core.

5. The lens mold assembly of claim 3, wherein the upper surface of the replaceable die core is higher than the upper surface of the base.

6. The lens mold assembly of claim 3, wherein the upper die comprises an outer lateral surface, and the outer lateral surface of the base is coplanar with the outer lateral surface of the upper die.

7. The lens mold assembly of claim 1, wherein the upper die, the upper die core, the bottom die and the bottom die core cooperatively define a room, and the room has a same profile as that of the optical lens for forming the optical lens.

8. A lens mold assembly for manufacturing an optical lens for an LED for diverging light from the LED, comprising:
an upper die;
an upper die core received in the upper die;
a bottom die; and
a bottom die core received in the bottom die;
wherein the upper die core has a bottom surface, the bottom surface has a profile corresponding to a profile of a top portion of the optical lens, the bottom die comprises a base and a replaceable die core removably received in the base, the replaceable die core has an upper surface, and the replaceable die core defines a chamber depressed downwardly at a middle of the upper surface thereof, the chamber being configured for forming a bottom portion of the optical lens, and the replaceable die core defines a plurality of fixing holes recessed downwardly from the chamber and configured for forming positioning feet of the optical lens, the upper die, the upper die core, the bottom die and the bottom die core cooperatively define a room, and the room has the same shape as the optical lens to thereby form the optical lens by injection molding plastic material in the room.

9. The lens mold assembly of claim 8, wherein the upper die defines a void, and the upper die core is received in the void.

10. The lens mold assembly of claim 8, wherein the base comprises an upper surface, a lower surface and an outer lateral surface interconnecting the upper surface with the lower surface, the base defines another chamber depressed downwardly at a middle of the upper surface thereof, and defines a first hole extending upwardly from a center of the lower surface thereof to communicate with the another, the replaceable die core is removably received in the another chamber of the base.

11. The lens mold assembly of claim 10, wherein the replaceable die core defines a second hole thereof, the second hole is aligned with the first hole, the first hole and the second hole are both communicated with the chamber of the replaceable die core, the bottom die core is received in the first hole of the base and the second hole of the replaceable die core, and the top portion of the bottom die core is located in the chamber of the replaceable die core.

12. The lens mold assembly of claim 10, the upper surface of the replaceable die core is higher than the upper surface of the base.

13. The lens mold assembly of claim 10, wherein the upper die comprises an outer lateral surface, and the outer lateral surface of the base is coplanar with the outer lateral surface of the upper die.
